(19) United States
(12) Patent Application Publication
(10) Pub. No.: US 2010/0132304 A1
(43) Pub. Date: Jun. 3, 2010

(54) Apparatus and method for preventing damage to wood flooring during attachment to a subfloor

(76) Inventor: Gary Steve Burchette, Cartersville, GA (US)

Correspondence Address: ROBERT W PITTS, PO BOX 11483, WINSTON-SALEM, NC, 27116-1483, US

(21) Appl. No.: 12/454,543

(22) Filed: May 19, 2009

Related U.S. Application Data
(60) Provisional application No. 61/128,155, filed on May 19, 2008.

(51) Int. Cl. E04B 1/61; E04B 5/00; B25C 1/04

(52) U.S. Cl. 52/745.13; 52/745.21; 227/130; 173/211

(57) ABSTRACT

An apparatus and method of installing a hardwood floor employs a pneumatic or other impact fastener tool to drive staples, cleats, nails or other fasteners at a prescribed angle into and through the tongue of a solid or engineered hardwood flooring board having a standard profile and into a subfloor. The tool and method employs at least one inertia braking member, such as pads formed of rubber, foam, cork or other materials, that cushion the impact of a driving blade on the fastener and slow the final insertion of the fastener into the wood. Damage to the wood, such as splitting, shearing, pinching or puckering is prevented and overwood-underwood problems that are related to pinching and puckering do not arise. The inertia braking members are positioned inside a cylinder in which the driving piston and blade move and are easily replaceable when worn.

### CROSS REFERENCE TO PRIOR CO-PENDING PATENT APPLICATIONS

This application claims the benefit of prior U.S. Provisional Patent Application 61/128,155 filed May 19, 2008.

### BACKGROUND OF THE INVENTION

1. Field of the Invention

This invention relates to the installation of solid or engineered hardwood flooring by driving fasteners, such as staples or cleats, into standard tongue and groove boards. This invention also relates to the use of pneumatic or other impact type tools to install such flooring. Furthermore, this invention relates to the prevention of damage to hardwood flooring caused by excessive force applied by pneumatic or impact type tools.

2. Description of the Prior Art

Manual and pneumatic fastener tools, such as staplers or nail guns, are commonly used to deliver or drive a staple or cleat to affix tongue and groove hardwood or other flooring to a subfloor. In building construction, hardwood flooring is often used as a final top floor system giving the overall flooring system a more ridged and long life facial covering, as well as improving the appearance and marketability of the building. Hardwood flooring of this type is generally intended to last the entire life of the building and can represent a rather expensive or significant investment.

The National Wood Flooring Association (NWFA) in conjunction with the National Oak Flooring Manufacturers Association (NOFMA) and the National Maple Flooring Manufacturers Association (NMFMA) have adopted a standard profile for hardwood flooring boards, which is referred to as a NOFMA standard profile. FIG. 1 shows a standard profile of a board 2 having a tongue 4 extending from a main exposed section of the board 2 and a groove 6 extending into the opposite edge of the board 2. The configuration shown in FIG. 1 is a five (5) inch wide plank board. There are numerous dimensions for NOFMA standard profiles. Of course the tongue 4 of one board will fit within the groove 6 of an abutting and adjacent board. This standard profile also includes a V-notch 8 located along the intersection of juncture of the tongue 4 with the lead main section of board 2. This V-notch groove is intended to receive a staple or nail, which is driven at an angle though the hardwood flooring board 2 and into the subfloor on which the board 2 rests. The V-notch 8 provides sufficient room for a nail head of the bight or crown of a staple so that the tongue 4 will properly fit within a mating groove 6 so as not to interfere with the tight fit needed in a properly installed hardwood floor. The V-notch groove or bed 8 is most often 6.3 mm below the facial surface of the hardwood board. FIG. 2 shows the position of a properly inserted staple 10, which extends at an angle through the hardwood flooring board 2 and into and through the subfloor 12.

Hardwood flooring can either be solid wood flooring or engineered wood flooring. A solid wood flooring board is made and shaped from a singular piece of wood flooring material For example, a NOFMA standard solid wood floor which is ¾ inch thick by 3¼ inch wide and of random length is constructed or molded out of a single board of hardwood material that has a rough dimension going into a molder or shaper of approximately 1 inch by 3½ inch wide and of random length. The only difference between different NOFMA standard wood floors is the width. A 2¼ inch NOFMA standard profile is also ¾ inch thick and has the same tongue and groove configuration with the same V-notch bed.

An engineered wood floor is fabricated from hardwood and soft wood constituents. The layering of these constituents is often done in alternate directions so as to use the tensile strength of the grain and fiber as a truss building block. The top precious layer can vary in thickness for more efficient use of the desired material and for service longevity. The internal layers and components can be formed of less precious materials that often have desirable constructional attributes making the engineered floor more dimensionally stable than the solid hardwood floor. Most engineered wood floors are more costly to build than solid wood floors. However, it has been found that the inertia braking system of the instant invention can be advantageously employed to reduce damage to either solid or engineered hardwood floors.

Although it is possible to drive a nail or staple to its proper depth, as illustrated by FIG. 2, using a general purpose manual or pneumatic stapler or nail gun, it is unfortunately too common for the nail or staple 10 to be driven too far into the hardwood flooring board as demonstrated by FIG. 3. General purpose powered fastening tools, such as staplers or nail guns provide no means of inserting a fastener to its proper depth with the proper force. Some have suggested that fastener insertion depth can be controlled using pneumatically activated fastener tools by varying the pressure applied to the pneumatic fastener tool. Commonly the pressure that will be available from an external source, such as a compressor, can range from 100 psi. to 120 psi., and it has been suggested that pneumatically powered fastener tools, such as staplers and nail guns, be operated with input pressures regulated to 90 psi. It has been found that at pressures below 70 psi., fasteners, such as staples, cannot always be fully inserted, resulting in a situation such as shown in FIG. 4. Thus recommended pressure is between 70 psi. and 90 psi. and some have suggested that pressure variations within this range will prevent damage to hardwood flooring. However, it has been found that splitting and other damage will occur in this range of pressures, and pressure regulation is not believed to be a complete or even partially reliable method of avoiding damage to hardwood flooring.

When a staple 10 or other fastener is driven beyond its proper depth, as shown in FIG. 3, the hardwood flooring can be damaged. In common situations, the hardwood flooring boards can be splintered when the fastener is inserted to an excessive depth. In other instances, the flooring board may not split at the time of installation, but excessive stress can build up in the wood, that can cause subsequent rupture or splitting, that is not apparent at the time of installation, and only becomes a problem after the stresses promote damage over time due to wear and tear and the exposure to cycles of temperature and moisture. Even though over insertion is a problem, inadequate insertion, such as that shown in FIG. 4 would prevent two mating boards from mating because of interference by the staple 10 or other fastener. Thus, it is not possible to solve the problem of over insertion by reducing the force applied to the fastener. Even when the magnitude of externally sourced pneumatic pressure is at the lower end of its acceptable range, full insertion of the fastener must still be achieved.

FIG. 5 illustrates one type of damage that can be caused by an improperly inserted staple 10. Here three staples have been shot using a conventional pneumatic nail flooring gun with the staple extending beyond the boundaries of the NOFMA regulated V-notch bed 8. The crown of at least one staple 10 has lodged internally inside a ¾ inch solid wood flooring. The staple has wedged apart the wood causing splitting cracking, and shearing 14 of the expensive wood extending two to five inches on each side of the staple along the plane of the V-notch bed 8 adjacent the staple crown on each of three staples 10. In addition to the visible split, the overinserted staple has created a pinch down in all of the wood fiber zone below the staple and tongue. The split generated from the wedged staples 10 creates a top surface pucker 16 on the lead main section above the tongue as well as a bottom planar wedge and pinch down so that this damaged board may not properly fit in the mating groove in an adjacent board. When the tongue of the hardwood flooring is over pinched or over stressed insertion of that tongue into the groove of the next adjacent groove will cause the groove edge to elevate upward making the flooring uneven with the connection seams having an over wood-under wood condition that is both visible and can ultimately result in structural problems. This current problem has yet to be solved or resolved and is believed to be responsible every year for significant damage or destruction of solid wood and/or engineered wood flooring components.

Current pneumatic staple tools shoot a 15.5 gauge staple with a ½″ crown. These prior art guns employ a base plate or base member or foot adapter, whose purpose is to realign the angle, pitch, and altered plane of initial impact, so as to fasten a tongue and groove product at approximately a 45 degree angle to the substrate with staple initially striking on the lead edge of the tongue and groove product approximately 6.3 mm below the plane of the surface. Guns employing these characteristics are the primary means of installing solid hardwood flooring.

FIG. 6 illustrates a solid hardwood flooring board that has been properly stapled. The staples 10 are now properly aligned in the V-notch bed and properly lie therein without breaking through the wood adjacent the V-notch bed into the inner wood tissue fiber. No splits, swelling or pucker are present in the wood. The apparatus and method of the present invention will reliably result in proper insertion of fasteners, such as staples 10 in the V-notch bed 14 of a solid or engineered hardwood flooring board and will reduce the variability inherent in prior art techniques.

The problem of properly stapling a wood flooring board is further complicated by the wide variety of wood that is used for flooring and hardwood flooring, either as solid flooring or as engineered hardwood flooring. Among the species of wood that is used for flooring are oak, maple, hickory, pine, walnut, cherry, jatoba, wenge, cumaru and other wood species including domestic exotics and foreign exotics. Species that have been employed for wood flooring range from white pine to Brazillian walnut, which range from 420 to 3684 on the Janka Hardness Scale, which is a recognized standard scale in the wood flooring industry. Other things being equal, in most cases the harder the wood, the more damage that will result from a failure of the staple gun to properly insert a staple.

### SUMMARY OF THE INVENTION

An apparatus for attaching wooden flooring boards having a tongue and groove configuration to a subfloor includes a piston driven within a cylinder to drive fasteners into the wooden flooring boards. A magazine containing fasteners sequentially delivers the fasteners, such as staples, into alignment with the piston. At least one inertia braking member is positioned in the cylinder and directly or indirectly engages the piston, prior to completion of a full piston stroke. The inertia braking member absorbs force imparted by the piston and slows insertion of the fastener while fasteners are being sequentially driven into the flooring boards to prevent damage to the flooring due to overinsertion of any fastener.

A pneumatically driven fastener tool according to this invention have a body including a cylinder. A piston is driven from a retracted to an extended position by the application of pneumatic pressure. A fastener driving blade is mounted on the distal end of the piston. A magazine retains a plurality of fasteners that can be sequentially advanced into alignment with the fastener driving blade when the piston is retracted. An adapter foot aligns the fastener driving blade and a fastener aligned therewith a hardwood flooring board. The pneumatically driven fastener tool also includes at least one inertia braking pad positioned coaxially with the piston between the piston and a front wall of the cylinder. The inertia braking pad or stack of pads has a thickness sufficient to be compressed while the fastener driving blade is driving a fastener into and through a hardwood flooring board to absorb energy so that the travel of the fastener into the hardwood flooring board is slowed during the final portion of the insertion of a fastener into the flooring so as to prevent damage to the hardwood flooring board.

According to this invention, a method of installing hardwood flooring includes the following steps. A hardwood board is positioned on a subfloor. A fastener is disposed in a fastening tool aligned with the hardwood board at an intersection of a tongue in the board and the lead edge of a main portion of the hardwood board. A force is applied to a driving blade in the fastener tool to drive the fastener aligned with the hardwood board through the hardwood board to attach the hardwood board to the subfloor. Damage to the hardwood flooring board is prevented by braking the inertia of a piston driving the driving blade at the end of the stroke of the piston by compressing at least one inertia braking pad located in the fastening tool between the piston and a tool body in which the piston moves.

The inertia braking system of this invention has shown improvement in limiting the damage to wood flooring for a number of different commonly used wood species. It is believed that improvement will result for all species regardless of the Janka hardness value of the particular species, although the improvement may not be uniform for different species having a different hardness.

### BRIEF DESCRIPTION OF THE DRAWINGS

FIG. 1 is a section view of a solid hardwood flooring board showing the standard NOFMA profile of this tongue and groove configuration.

FIG. 2 is a section view of a solid hardwood flooring board showing a fastener, such as a staple, driven into the hardwood board to a proper depth so that the crown of the staple rests within the standard V-notch at the intersection of the tongue with the main portion of the board.

FIG. 3 is a section view similar to that shown in FIG. 2, but showing a staple that has been inserted beyond its proper depth.

FIG. 4 is a view similar to FIGS. 2 and 3, but showing incomplete insertion of a staple.

FIG. 5 is a three-dimensional view illustrating typical damage that often can result from overinsertion of a fastener, such as a staple, as shown in FIG. 3.

FIG. 6 is a three-dimensional view similar to FIG. 4, but showing a properly inserted fastener without damage to the solid hardwood flooring board.

FIG. 7 is a view of a fastening tool, such as a pneumatically driven stapler having features in accordance with this invention. The tool shown in FIG. 7 includes a magazine for fasteners, such as staples, but does not include an adapter foot for aligning the tool with the V-notch bed employed in standard hardwood flooring.

FIG. 8 is also a view of the fastening tool shown in FIG. 7 with the addition of an adapter foot for aligning the tool with the V-notch bed employed in standard hardwood flooring. The adapter foot and the magazine have been omitted from FIGS. 9-12 in order to better illustrate other components of this tool.

FIG. 9 is a view, partially broken away, showing the piston in the cylinder of the tool of FIGS. 8 and 9. The bumper and the inertia braking pads have been left out of this view to better illustrate other components of this tool.

FIG. 10 is a view, similar to FIG. 9, but showing the hard rubber bumper employed to prevent impact damage to the tool as the piston is activated. The inertia braking pads have been deleted from this view to better illustrate other components.

FIG. 11 is a view similar to FIGS. 9 and 10, but showing the inertia braking pads. The tool is shown in the partially retracted position in this view.

FIG. 12 is a view of the tool of FIG. 11, but showing the piston in an almost fully extended position The inertia braking pads have been engaged but not yet been compressed in this view, and the hard rubber bumper has also been engaged, but has not yet absorbed an excessive impact force to prevent the fastener tool from being damaged.

FIG. 13 is an exploded view of a fastener tool in accordance with this invention containing the components also shown in FIGS. 8-12.

FIGS. 14A-14C are side views of three alternative inertia braking pad.

FIGS. 15A-15C are top views of the three alternative inertia braking pads shown in FIGS. 14A-14C.

FIGS. 16A-16C are section views of the three alternative inertia braking pads shown in FIGS. 15A-15C, taken along the corresponding section lines 16A-16C shown in FIGS. 15A-15C.

FIG. 17 is a photograph showing staples inserted by the prior art technique to secure hardwood flooring to a subfloor.

FIG. 18 is a photograph showing staples inserted using the inertia braking method to secure hardwood flooring to a subfloor.

### DETAILED DESCRIPTION OF THE PREFERRED EMBODIMENT

The purpose of this invention is to allow all piston thrust energy and drive blade energy in a fastening tool to remain intact and in force as a staple or cleat penetrates the fiber of a hardwood flooring board at the proper angular orientation, piercing through the hardwood flooring fiber, tissue, and grain and protruding from the underneath side. With the energy and force of a fastening tool piston and drive blade remains intact causing staples or cleat pins to pierce the surface of the substrate, and, indeed through the thickness of the substrate, and, if necessary, into a secondary substrate. All of this energy from piston and drive blade is in place until the proper time and point at which energy and force directed by the piston and drive blade of the staple or cleat is absorbed by the inertia braking system described herein, so as to land the staple or cleat in a soft landing with the crown of the staple or the head of the cleat properly positioned in the NOFMA regulated V-notched bed without the crown of the staple or head of the cleat having excessive energy to brake down the wood grain fiber of the v-notch bed. Countersinking the said staple or cleat is thus avoided. Countersinking would split the wood grain of the precious target material and puckers the overall thickness of the said target material. Such splits can often take place without the use of the inertia brake system. Splits weaken the overall grip of the staple or cleat due to the splitting and shining of the wood fiber, however, it also has the adverse effect of overpinching the lead edge of the precious flooring material. In other words, it is overpinched initially, having altered the overall thickness of the lead edge of the hardwood flooring material, as inside that split now lies a 15.5 gauge wedge, otherwise known as a cleat or staple, wedging the two panels of the split apart and generating an internal wood explosion which often exonerates itself through seasonal and moisture atmospheric condition changes.

It is not part of the proper staple or nailing process to drive the cleat or staple to a different depth depending upon the material employed in the flooring or the substrate. Indifferent of the substrate material or the wood floor material, the key is not the depth of the drive, as it may be required by the flooring installer to us a 1½″ staple or cleat, or a 2″ staple or cleat in order to meet specific installation specifications for a said project. The depth of the drive should only be altered by the length of the staple or cleat component, however the final position of the crown or head should always remain the same. If indeed the crown of the staple or head of the cleat is left short of its landing position, this is also a negative installation issue. Hence, the inertia brake system is designed to leave intact enough energy from the piston and drive blade so as to finalize the delivery of the cleat or staple with a slight degree of force and energy still in tact, so as to snug the head of the cleat, and, or the crown of the staple up tight in the NOFMA regulated v-notch bed, once again without breaking down the base of the V-notch bed. The size of the inertia braking members 40 or the stack of inertia braking pads is not affected by the length of the fastener or the hardness of the wood into which the fasteners are to be inserted.

In order to really understand a solution to the problem of damaging wood flooring attached used a pneumatic or other impact type fastener tool, it has been necessary to conduct an in depth analysis of the problem. As a result of this analysis, it has been determined that the cleat or staple to be first of all a compressed component, having most of its delivery done by piston drive pin pressing a staple or cleat into position. The rubber bumper that is currently utilized in all of these hardwood flooring pneumatic devices allows for a continuous press and then a sudden and abrupt stop much like unto the concept of the truck striking the cement wall. However, the cleat or staple still has inertia after the sudden stop of the piston by a conventional bumper. The inertia brake system, however, slows down that final thrust and brakes the power of the propellant.

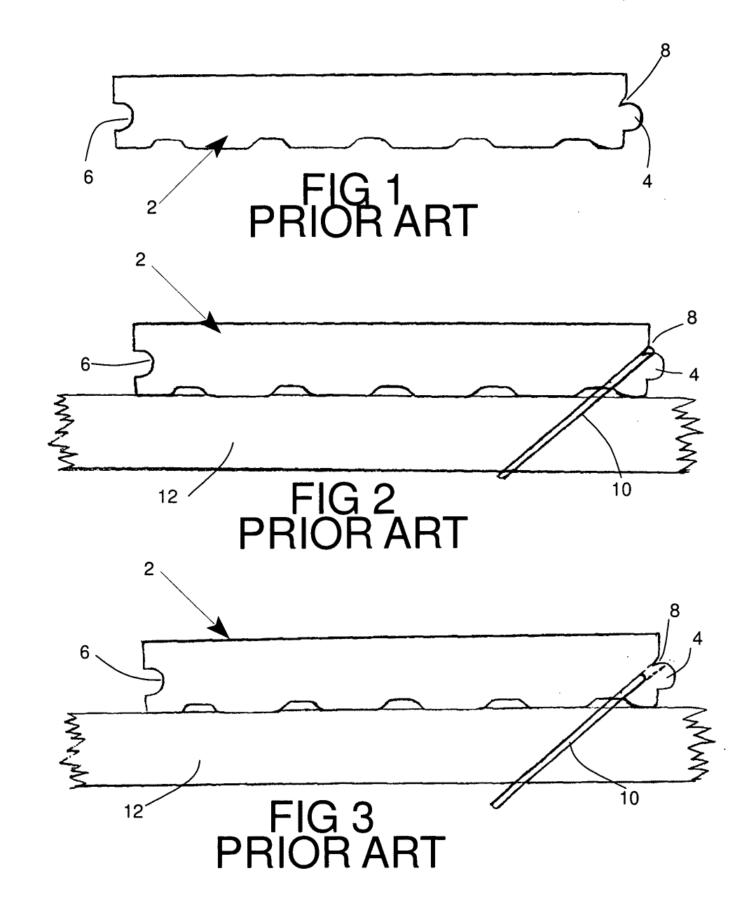

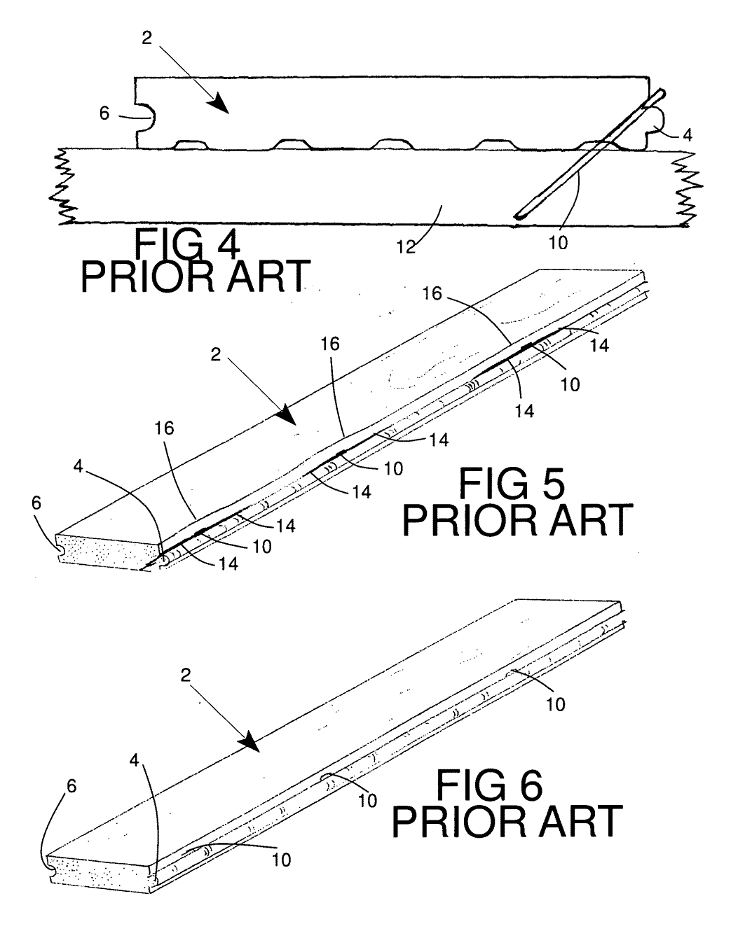

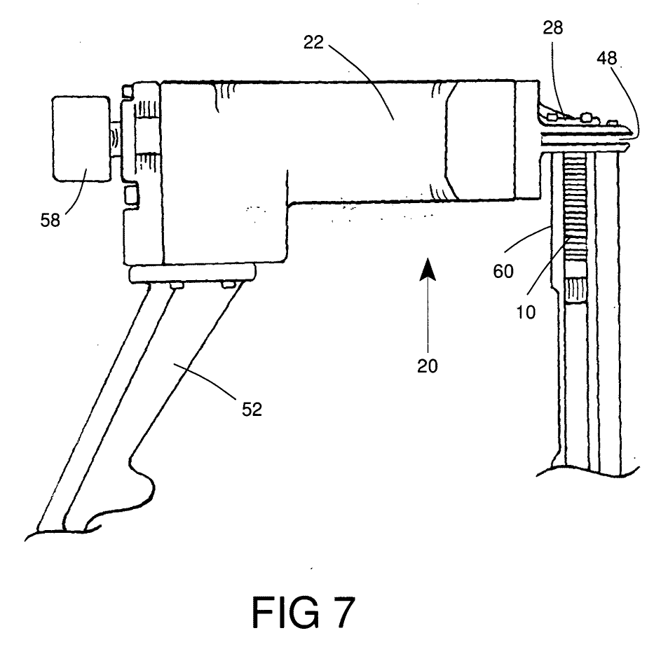

Proper attachment of each board in a hardwood floor as shown in FIGS. 2 and 6 can be achieved with a fastening tool 20 as shown in FIGS. 7-13. A pneumatic stapler is depicted in FIGS. 7-13, and this stapler is intended to be representative of pneumatic or manual fastener tools suitable for properly installing hardwood flooring without the defects shown in FIGS. 3-5. Although a properly installed hardwood floor can be achieved by using other pneumatic and manual fastening tools, and problems do not result in every installation, problems have been encountered on an all too frequent basis when conventional fastener tools have been employed to install hardwood flooring. The instant invention has been found to significantly improve the reliability of the installation of hardwood flooring by reducing the frequency of improperly inserted fasteners, such as the staples 10 employed with the representative pneumatic stapler fastening tool 20.

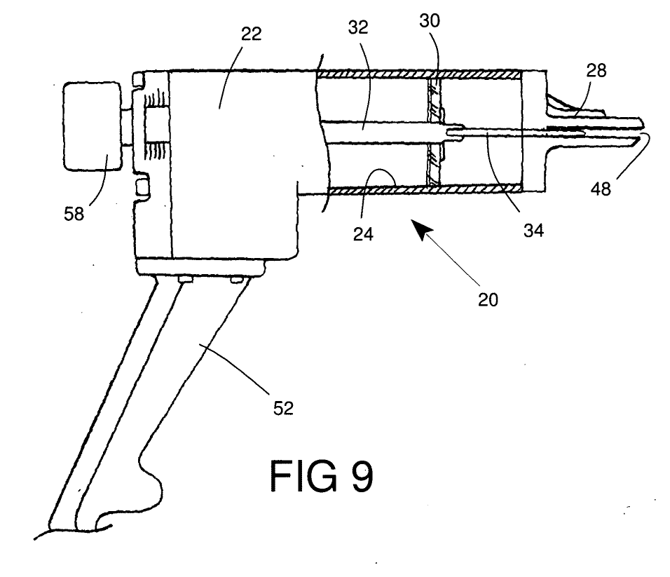

FIG. 7 is an exterior view of a fastening tool 20, that together with standard accessories, and the use of the inertia braking members, bushings or pads 40 will improve the efficiency of this tool 20 when used for installing hardwood flooring. The inertia braking pads 40 are mounted in the interior of the fastening tool 20 and are therefore not visible in FIG. 7. Fastening tool 20 includes an outer body 22 to which a magazine 60 is attached. The magazine 60 houses a row of fasteners 10, which in this case comprise construction staples that are fed into a foot 28 on the front of the tool 20, and into a slot 48 in the foot 28. The foot 28 has a slot 48, that is large enough to receive a driving blade or pin 34, shown in FIGS. 9-13, when the tool is actuated. The driving blade 34 will be propelled and will drive an aligned staple 10 into the V-notch 8 of a hardwood board 2. The tool 20 also includes a handle 52 that is gripped by an installer and a cap 58 located on the rear of the tool 20. The fastening tool 20 is attached to an external source of pneumatic pressure, such as a compressor. The fastening tool 20 is then activated by striking the cap 58 with a mallet after the tool has been properly positioned relative to a hardwood flooring board 2.

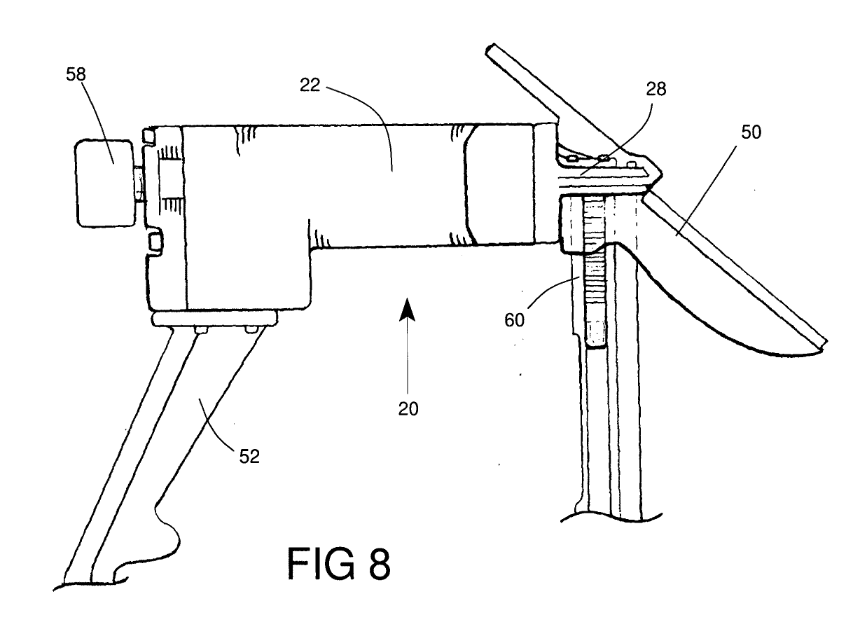

FIG. 8 also shows the exterior of the fastening tool or pneumatic stapler 20, but an adapter foot 50 has now been mounted on the front of the tool. The adapter foot 50 is keyed so that when the adapter foot 50 is placed on a hardwood flooring board 2 positioned on a subfloor for attachment, the driving blade 34 and a properly positioned staple will be aligned with the V-notch 8 of a standard NOFMA hardwood flooring board. The tool 20 will be aligned so that a staple can be driven at an angle, normally of forty-five degrees, through the board and into the subfloor 12 as shown in FIG. 2. After the inertia braking pads have been installed, the installer can operate the new fastening tool 20, during actual insertion of a fastener, in the same manner that the installer would employ a conventional fastener tool, such as staplers or nail guns.

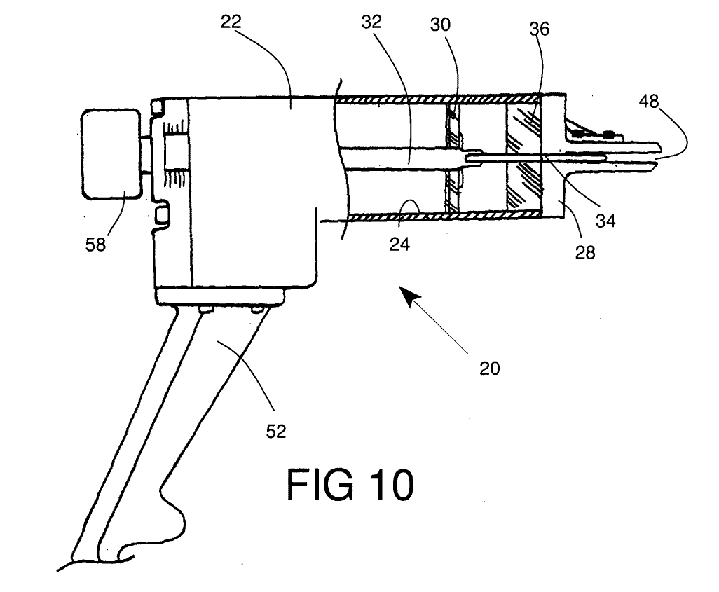

FIG. 9 is a view, similar to FIG. 7, in which a portion of the exterior housing or body 22 has been cut away to expose the piston 30 and the cylinder 24. The cylinder 24 is formed within the body 22, and the piston 30 is dimensioned to slide within cylinder 24. The piston 30 is mounted on a piston rod 32, which will be driven toward the front of the tool 20 when the cap 58 is struck with a mallet. A driving blade 34, which fits within slot 48 on the foot will drive a fastener that is aligned with the driving blade 34. FIG. 10 is a view similar to FIG. 9, but it shows a bumper 36 that is located at the front of the cylinder 24. The bumper 36 is cylindrical and has substantially the same diameter as the piston 30. The bumper 36 is fabricated from a hard rubber or other elastomer and functions to prevent damage when the piston 30 is accelerated toward the front of the tool. At the end of its stroke, the piston 30 strikes the rubber bumper 36 and force that would otherwise impact the foot 28 or other portions of the body 22 or the tool will be dampened. The rubber bumper 36, or a similar component, is employed with conventional pneumatic fastener tools, and in the preferred embodiment is a different component than the inertia braking pads 40 that will be subsequently described in greater detail. It should be understood that, in light of the description of the inertia braking pads 40 contained herein one of ordinary skill in the art, could modify a conventional bumper member to include both insertion depth control inertia braking functionality without sacrificing the impact protection offered by conventional bumpers. However, the preferred embodiment depicted herein, is still believed to offer the advantages of simplicity.

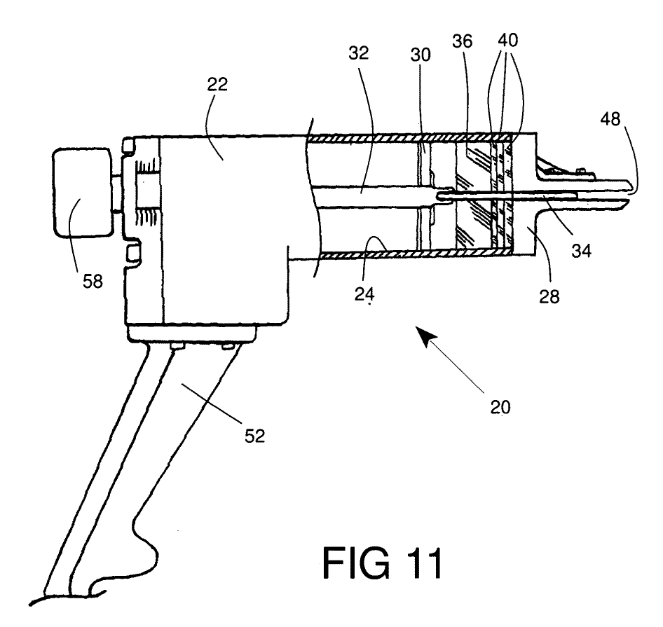

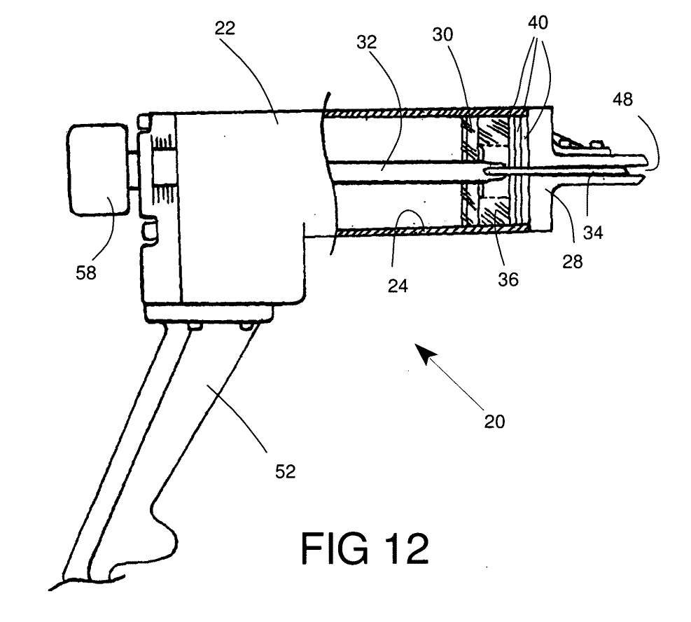

FIG. 11 shows a stack of three inertia braking members or pads 40, that are positioned between the rubber bumper 36 and the end of the cylinder 24 defined by the back face of the foot 28. The inertia braking pads 40 are cylindrical and in this embodiment have the same diameter as the bumper 36. Both the inertia braking pads 40 and the bumper 36 have a hole that will permit passage of the driving blade 34. The inertia braking pads 40 can be fabricated from a foam, such as a closed or open cell polyolefin or other flexible foam or a thermoplastic or a thermoset or a hard rubber or from a semi hard rubber or elastomer or a natural material, such as cork or hevea, and or other materials. The inertia braking pads 40 are most often softer than the bumper 36, with a different durometer as well as a different elasticity than the bumper 36. In other words, the inertia braking pads 40 are more compressible than the bumper 36, and will slow the final delivery of the fastener by gradually slowing the piston 30 and driving blade 34. The inertia braking pads 40 will also bring the fastener to a controlled, precise final position that will not damage the wood. It is believed that the addition of the new member or members works with the bumper 36 in braking down the energy of the pneumatically driven piston in much the same way as multi layered armor brakes the energy of a projectile. It should be understood, however, that this explanation is merely an attempt to describe one possible explanation of the phenomena that has been observed and is not presented to limit or further define this invention. Future study may result in a more complete understanding of the underlying cause for the improved performance of this invention, and therefore this possible explanation does not limit the scope of the invention described herein. Although the inertia braking pads 40 are located between the bumper 36 and the foot 28 in FIG. 11, it should be understood that the inertia braking pads 40 can also be located between the bumper 36 and the piston 30. Inertia braking pads 40 can also be positioned on opposite sides of the bumper 36. Although a stack of three inertia braking pads 40 are shown in FIG. 11, it should be understood that fewer pads or more pads can be employed if needed, and the number and depth of the pads 40 can be altered. FIG. 11 shows the piston 30 in a partially retracted position, spaced from the bumper 30. Comparison of FIG. 10 with FIG. 11, shows however that a smaller gap exits between the piston 30 and the bumper 36 in FIG. 11 than in FIG. 10 in which the addition of the inertia braking pads 40 has shifted the bumper toward the piston 30 in the partially retracted position. FIG. 12 shows the tool 20 with the piston 30 near the extended position at the end of its stroke. At this point the inertia braking pads 40 are about to be placed under compression while the driving blade 34 is driving a staple, through the final portion of insertion through a hardwood board 2 and into the subfloor. The inertia braking pads 40 will compress to a greater degree than the bumper 36, so that the fasteners will be gradually inserted to their proper depth during the final portion of the insertion stage.

A representative example of the use of inertia braking pads 40 can employ three foam pads 40 in a stack. Each foam pad has an initial thickness of 2 mm. It has been observed that reliable insertion, without damage to standard NOFMA flooring, of a 15 gauge flooring staple having a standard ½ inch crown can employ three foam pads 40 having this initial or undeformed thickness. It has been observed that each of the three pads 40 are compressed during the piston stroke. It has been observed that the first pad 40, adjacent to the piston 30 will be compressed to a final thickness of 1 mm. In other words the foam pad will be compressed by 1 mm. The middle pad 40 will also be compressed by the same amount, and will have a minimum thickness of 1 mm. The third pad 40 adjacent to the bumper 36 will only compress by 0.5 mm and will have a minimum thickness of 1.5 mm. The entire stack will be compressed by 2.5 mm and will have a final thickness of 3.5 mm. This example resulted in satisfactory performance for one staple gun. Other staple guns, including others having different factory bumpers, can employ an inertial braking system and inertial breaking pads having different dimensions, densities and characteristics. There does not appear to be a direct correlation between the cumulative pad thickness change during compression and the size of the staple nor the density of the wood flooring component. It is believed that the inertia braking performance of multiple pads in a stack is superior to the inertia braking performance of a single pad.

It has been found that the combination of new components be it one, two, three, or more with the factory bumper 36 generates success in reaching insertion depth control for hardwood flooring staple 10. It is believed that this depth control is also directly related to the chain reaction of collision as the piston 30 strikes the bumper 36 that in turn strikes the new member or members 40, and thus generating the controlled final stop of the piston 30 and the drive blade 34, and ultimately yielding the proper delivery of each staple 10 into the NOFMA v-notch groove 8 of FIG. 1. It is believed that in using a new additional member or members whose density and structure may often vary from that of the factory bumper 36 inserted inside cylinder 24 at or near the foot 28 is the preferred systematic resolution of the damage observed when staples have been inserted using prior art techniques, and most often yields a better and proper delivery and seating of the each staple 10 against the NOFMA v-notch bed 8 identified in FIG. 1. Although the precise reason for the improvement realized by employing multiple inertia braking members 40 or employing a stack, including a bumper 36, is not fully understood, it may be that the vibrations imparted to the individual member in a stack are not transmitted continuously through the stack. Although each member will vibrate as a force is applied, the vibrations applied to the first member in the stack, may not be propagated directly to other members in the stack. As force is applied to subsequent members, each may vibrate, but the separation, even though minute, between members will prevent the stack from vibrating together, and will facilitate proper insertion of the staples into the wood without significant damage.

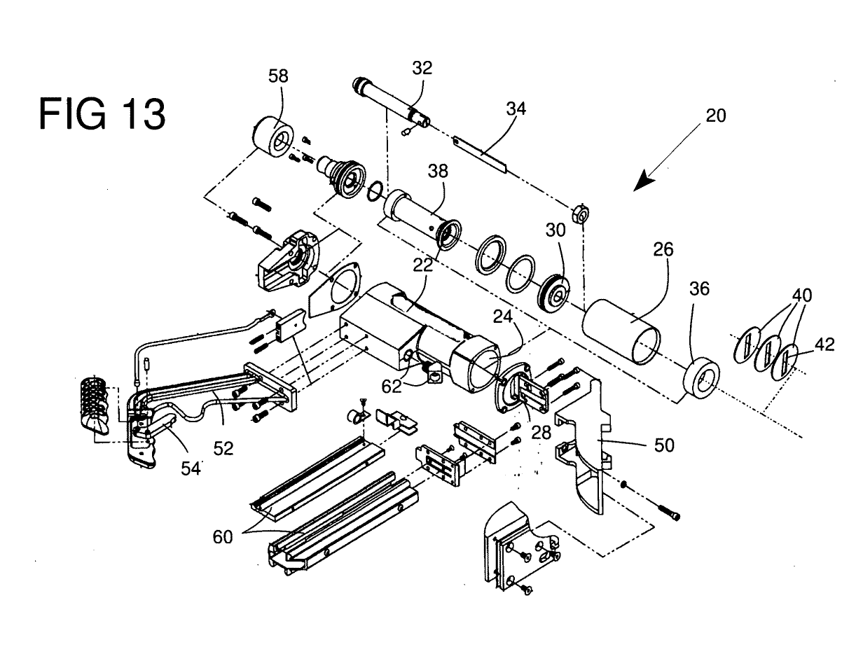

FIG. 13 is an exploded view of a fastener tool 20, such as that shown in FIGS. 7-12. The individual components of this tool including the inertial braking pads are identified as follows:
20 fastener tool
22 tool body
24 cylinder
26 cylinder sleeve
28 foot
30 piston
32 piston rod
34 driving blade
36 bumper
38 return cylinder
40 inertia braking pad
42 pad opening
48 slot
50 adapter foot
52 handle
54 trigger
56 trigger cable
58 cap
60 magazine
62 air intake

A piston assembly can be inserted into the cylinder 24 located in the tool body 22. A cylinder sleeve 26 is located in the cylinder 24 and the piston 30 has an outer diameter equal to the inner diameter of the cylinder sleeve 26. The piston rod 32 and the driving blade 34 are attached to the piston 30. A return cylinder 38 is also located within the cylinder 24 along with appropriate seals that allow pneumatic pressure to drive the piston from the retracted position to the extended position in which the driving blade 34 will deliver a driving blow to a fastener or staple 10 aligned therewith. Pneumatic pressure will also act to retract the piston. The action of the piston 30 and the manner in which the pneumatic pressure acts to impart motion in opposite directions is conventional in nature and can be the same that is used in prior art pneumatic fastener tools, such as staplers and nail guns. The manner in which the pneumatic pressure acts on the piston 30 is not part of the instant invention and therefore a detailed description would be unnecessary to one of ordinary skill in the art. An external source of pneumatic pressure, such as a compressor, is attached by a hose though the input port 62 on the tool body at the base of the handle 52. Examples of conventional fastener tools that can be modified by employing the inertia braking system described herein include the Powernail 445FS pneumatic stapler, the Duo-Fast 200-S model, the Bostitch MIIIFS model and the Primatech P-220 model.

A foot 28, having a slot, through which the driving blade 34 extends, is attached to the tool body 22 and closes the front of the cylinder 24. A fastener magazine 60 is attachable to the tool 22 and fasteners, such as staples 10 housed in the magazine can be sequentially advanced in the foot for alignment with the driving blade 34. A single fastener is advanced during each stroke of the piston 30 and driving blade 34. An adapter foot 50 is attached to the front of the tool 20 so that the tool can be properly aligned with the hardwood flooring board to be attached to the subfloor. The operator grasps the handle 52 and strikes the cap 58 to activate the piston 30 and initiate each stroke. A trigger 54 is provided as a safety feature. The installer merely grasps the handle 52 to align the adapter foot or base 50 with the V-notch on a board 2 at the proper angle. While depressing the trigger 54, the installer strikes the cap 58 with a mallet or other tool to drive each fastener into the board 2, and then moves the tool to the next location at which the next fastener is to be applied.

The bumper 36 and the inertia braking pads 40 can be inserted into the cylinder 24 before the foot 28 is fastened to the front of the tool body to close the cylinder 24. If the inertia braking pads 40 need to be changed, that can be easily accomplished by removing the foot 28 to provide access to the cylinder 24, after which the foot 28 is reattached. As shown in FIG. 13, the inertia braking pads 40 have openings or holes 42 that provide clearance for the driving blade 34. The bumper 36 also has a central opening.

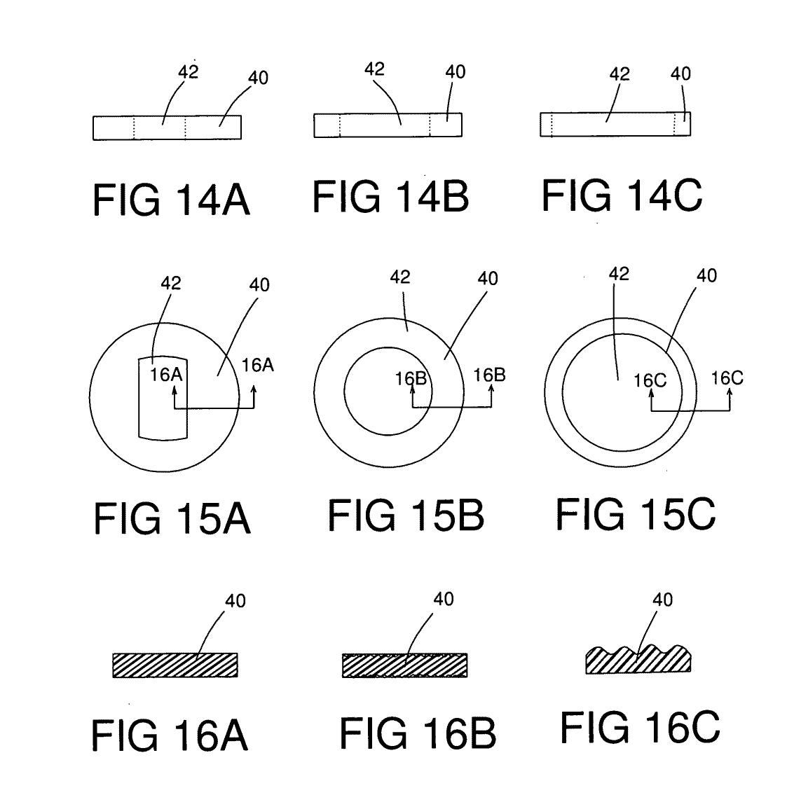

The precise configuration of inertia braking pads 40 can differ depending upon the type of material that is employed as well as the specific fastener tool in which the inertia braking pads are used. FIGS. 14A-C, 15A-C and 16A-C show three of the many alternative configurations that may be employed. The thickness of the individual pads can also vary, but a thickness of 3-4 mm. has been found to be effective. The mass of material will be a significant factor in determining the inertia braking performance of the pads, and of course it will be apparent to one of ordinary skill in the art that the precise dimensions may also affect the operation life of the pads. For example, the pads can be expected to lose some resiliency over their operating life, and the length of the operating life is one significant factor in choosing a specific design. As is especially apparent in the section views 16B-16C a foam material, such as an open or a closed cell polyolefin foam, is one material that has been found to be effective. However, other types of materials known to those of ordinary skill in the art can also be suitable. It is not even necessary that the individual pads be uniform. A laminate of different materials could be employed. As previously discussed, these inertia braking pads could also be combined with the bumper member in certain situations. For example, a laminate subassembly having different sections performing different functions could be employed. A compromise material may also be employed that will provide adequate protection for the fastener tool as well as proper fastener insertion, even if neither function is performed to the same level as would be achieved with separate members. This could allow elimination of the bumper used in conventional fastener tools.

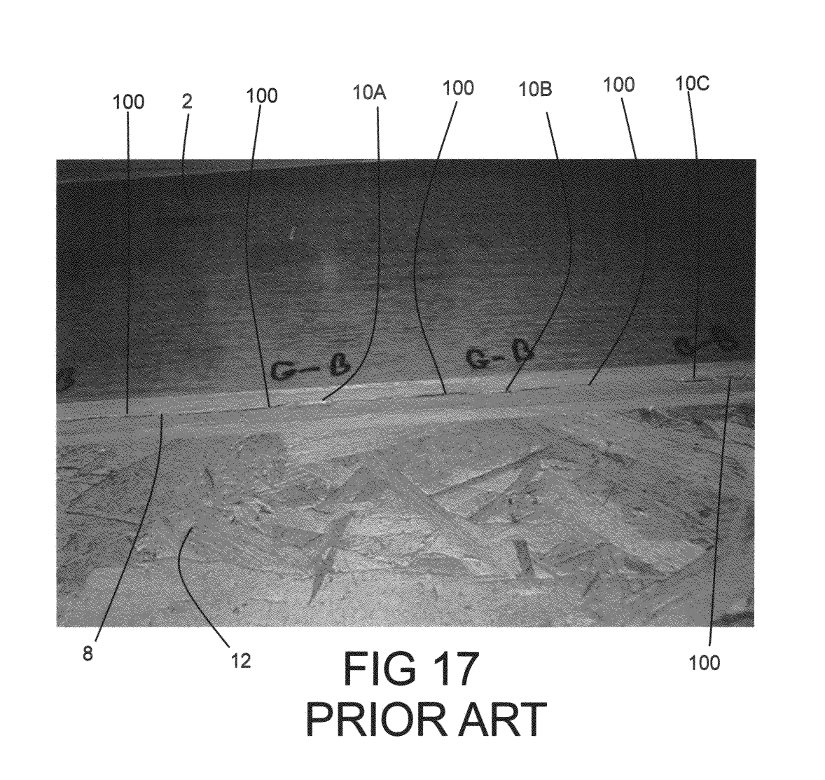

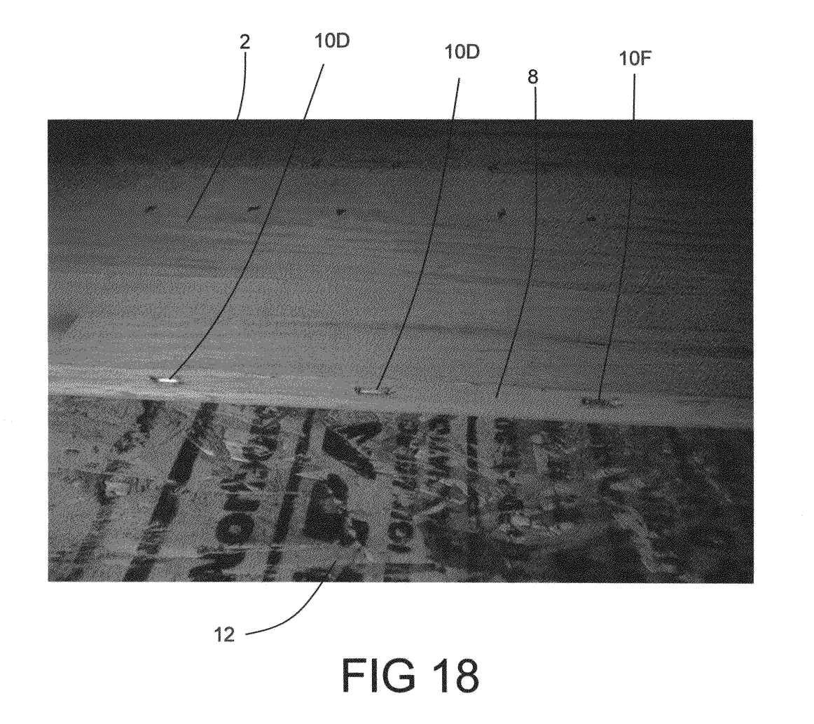

FIG. 17 is a photograph showing an example of the insertion of staples 10A-10C into hardwood flooring 2 on top of a wood subfloor 12 using the prior art technique. These staples 10 were inserted into a V-notch bed 8 using a conventional fastener tool 20 that did not employ the inertia braking system or include inertia braking pads. Splits 100 emanate from each staple 10A-10C and a virtually continuous split extends along the NOFMA v-notch 8. A comparison of the staples 10A-10C with the staples 10D-10F in FIG. 18 shows that the staples 10A-10C are less visible indicating countersinking due to the excessive insertion depth of these staples. It is estimated that only forty percent of each staple crown is visible in this example.

No splits emanate from staples 10D-10F in FIG. 18, which have been inserted using the inertia braking system depicted in the representative embodiment. The metallic surface of staples 10D-10F is clearly visible, especially when compared with staples 10A-10C in FIG. 17. The visibility of these metallic staples shows that overinsertion has been avoided and there is no visible countersinking around any of the staples 10D-10F. No splits are evident in the vicinity of any of the staples 10D-10F or along the NOFMA v-notch 8.

Although FIG. 17 does show surface splits 100, it should be understood that the depth of these splits 100 is not evident. It has been found that the depth of the splits 100 shown in FIG. 17 can be up to ¼ inch to ½ inch in certain locations. It has been found that significant splits will occur when the crown of the staple significantly penetrates the wood when the staple is over inserted. If the staple crown is pressed and thrust through the fibrous grain tissue of the board and is countersunk into the board, the staple crown forms a wedge. This penetration will generate sufficient energy to form an explosive split which will shear the wood. Such a split will not be confined to the surface nor will it form only a hairline split. It will penetrate deep into the body of the wood. The invention disclosed herein will reduce overpenetration of the staple, and especially the staple crown, and has been found to reduce both the incidence and severity of such splits.

Other configurations that do not employ a polymeric material might also be employed. For example, wave springs of the appropriate size and material might provide inertia braking. The inertia braking system can also be modified for use in installing decking. Although staples are the common type of fastener with which the inertia braking system is employed, it may also be employed in tools intended for use with cleats to install flooring boards. The inertia braking members could also be modified so that the member or members are attached to the piston instead of being placed in the cylinder. It should therefore be apparent that the instant invention is not limited to the embodiments depicted herein, and the invention is instead defined by claims.

1. An apparatus for attaching wooden flooring boards having a tongue and groove configuration to a subfloor, wherein the apparatus comprises:
a piston driven within a cylinder to drive fasteners into the wooden flooring boards;
a magazine for containing fasteners so that individual fasteners can be sequentially aligned with the piston; and
at least one inertia braking member positioned in the cylinder to act upon the piston prior to completion of a full piston stroke, wherein the inertia braking member absorbs force imparted by the piston while the each fastener is being sequentially driven into the flooring boards to prevent damage to the flooring due to overinsertion of any fastener.

2. The apparatus of claim 1 wherein the piston is pneumatically driven within the cylinder, and force imparted to the piston is dependent upon pneumatic pressure applied from an external source.

3. The apparatus of claim 1 wherein a bumper is provided in addition to the inertia braking member.

4. The apparatus of claim 3 wherein the inertia braking member is positioned adjacent to the bumper.

5. The apparatus of claim 3 wherein the inertia braking member is more compressible than the bumper.

6. The apparatus of claim 3 wherein the inertia braking member is softer than the bumper.

7. The apparatus of claim 3 wherein the inertia braking member has a different durometer and a different elasticity than the bumper.

8. The apparatus of claim 1 wherein a plurality of inertia braking members are positioned in the cylinder.

9. The apparatus of claim 1 wherein each inertia braking member is fabricated from a material selected from the group including rubber, foam, cork and other materials.

10. The apparatus of claim 1 further including an adapter foot being engagable with a flooring board so that fasteners can be driven through a notch formed adjacent the tongue of each flooring board.

11. The apparatus of claim 1 wherein the inertia braking member absorbs energy so that the wooden boards are not splintered along the tongue.

12. The apparatus of claim 1 wherein the inertia braking member has a density may have a range of density that is utilized to absorb energy so that the wooden boards are not splintered along the tongue.

13. The apparatus of claim 1 wherein each inertia braking member comprises a disc having a central opening through which at least a portion of the piston can pass.

14. The apparatus of claim 13 wherein the piston includes a blade, the blade passing through the opening in each inertia braking member.

15. The apparatus of claim 1 wherein the inertia braking member acts upon the piston to slow insertion of the fastener into the wooden flooring board during a portion of the fastener's travel.

16. The apparatus of claim 15 wherein the inertia braking member acts upon the piston to slow final insertion of the fastener into the wooden flooring board.

17. A pneumatically driven fastener tool for driving fasteners to attach hardwood flooring to a subfloor; the fastener tool comprising:
a body having a cylinder;
a pneumatically driven piston driven from a retracted to an extended position by the application of pneumatic pressure;
a fastener driving blade mounted on the distal end of the piston;
a magazine comprising means for retaining a plurality of fasteners that can be sequentially advanced into alignment with the fastener driving blade when the piston is retracted;
an adapter foot for aligning the fastener driving blade and a fastener aligned therewith a hardwood flooring board;
the pneumatically driven fastener tool being characterized by at least one inertia braking device positioned coaxially with the piston between the piston and a front wall of the cylinder, the inertia braking device having a thickness sufficient to be compressed while the fastener driving blade is driving a fastener into and through a hardwood flooring board to absorb energy so that the travel of the fastener into the hardwood flooring board is limited so as to prevent damage to the hardwood flooring board.

18. The pneumatically driven fastener tool of claim 17 wherein the inertia braking device comprises a plurality of inertia braking pads in a stack.

19. The pneumatically driven fastener tool of claim 17 further including a bumper member positioned coaxially with the piston and engaging at least one inertia braking pad

20. The pneumatically driven fastener tool of claim 17 attachable to a source of external pneumatic pressure ranging from 100 psi to 120 psi, regulated from 70 psi to 90 psi input to the pneumatically driven fastener tool, wherein the inertia braking pads prevent damage to hardwood flooring when pneumatic pressure is applied.

21. A method of installing hardwood flooring comprising the steps of:
positioning a hardwood board on a subfloor;
aligning a fastener disposed in a fastening tool with the hardwood board at an intersection of a tongue in the board and a lead edge of a main portion of the hardwood board;
applying a force to a driving blade in the fastener tool to drive the fastener aligned with the hardwood board through the hardwood board to attach the hardwood board to the subfloor;
preventing damage to the hardwood flooring board by braking the inertia of a piston driving the driving blade at the end of the stroke of the piston by compressing at least one inertia braking pad located in the fastening tool between the piston and a tool body in which the piston moves.

22. The method of claim 21 wherein the fastener is aligned with the intersection of the tongue in the board and the lead edge of the main portion, by positioning an alignment adapter foot with the hard wood board before driving the fastener into the hardwood board.

23. The method of claim 21 wherein multiple fasteners are disposed in a magazine so that the fasteners can be sequentially aligned along the hardwood board.

24. The method of claim 21 wherein the piston is pneumatically driven by an external source of pneumatic pressure attachable to the fastening tool.

25. The method of claim 21 wherein the fastener comprises a stapler and the fastening tool comprises a pneumatically driven stapler.

26. The method of claim 21 wherein splintering, shearing, bursting, puckering, and overpinching of the hardwood boards is prevented by braking the inertia of the piston while the fastener is being driven into the hardwood board.

27. The method of claim 21 wherein stresses in the hardwood boards arising when a fastener is driven through the hardwood board are reduced by braking the inertia of the piston while the fastener is being driven into the hardwood board.
